(19) United States
(12) Patent Application Publication
(10) Pub. No.: US 2026/0299547 A1
(43) Pub. Date: Oct. 1, 2026

(54) DISPLAY DEVICE FOR MACHINE TOOL

(71) Applicant: FANUC CORPORATION, Yamanashi (JP)

(72) Inventor: Masashi YASUDA, Yamanashi (JP)

(73) Assignee: FANUC CORPORATION, Yamanashi (JP)

(21) Appl. No.: 19/481,171

(22) PCT Filed: May 11, 2023
(86) PCT No.: PCT/JP2023/017814

§ 371 Date: Nov. 3, 2025

(51) Int. Cl. G05B 19/25; G06F 3/14

(52) U.S. Cl. CPC G05B 19/25; G06F 3/14; G05B 2219/37611

(57) ABSTRACT

Provided is a technique whereby overlapping of a tool path of a machine tool that uses a plurality of tool blades can be easily perceived in a display device for a machine tool. A display device 1 for a machine tool comprises a first tool path acquisition unit 12 that acquires relative first tool path information of a workpiece and a tool based on a relative rotation angle of a workpiece and a tool due to a first tool blade, a second tool path acquisition unit 13 that acquires relative second tool path information of the workpiece and the tool based on a relative rotation angle of the workpiece and the tool due to a second tool blade, and a display control unit 14 that displays a first tool path indicating a path of the first tool blade and a second tool path indicating a path of the second tool blade on the same display unit 20 on the basis of the first tool path information and the second tool path information.

### TECHNICAL FIELD

The present disclosure relates to a display device for a machine tool.

### BACKGROUND ART

In oscillation cutting, chip shredding occurs when the current tool path ((n+1)-th tool path) has an overlap with the previous tool path (n-th tool path), i.e., when an air cut occurs. Patent Document 1 describes a technique for checking such an overlap between tool paths.

As seen in, for example, drilling and balance cutting, when machining the same workpiece with a plurality of tools (edges) concurrently, chip shredding may also occur if the routes of the plurality of tools have an overlap therebetween. Patent Document 2 describes a technique for the animation-rendering of a simulation of concurrent machining with a plurality of tools.

When performing machining with a plurality of tool edges, the distances between relative cut routes between a workpiece and the tools becomes shorter by the number of tool edges in comparison to when machining is performed with one tool edge. Thus, if the machining condition is the same, an air cut easily occurs when machining is performed using a plurality of tool edges. In a case where machining is performed using a plurality of tool edges, an air cut occurs not only when the current tool path ((n+1)-th tool path) has an overlap with the previous tool path (n-th tool path) but also when the tool paths of a first tool edge and a second tool edge have an overlap therebetween. Thus, a larger number of tool edges are more advantageous when consideration is given to chip shredding.

### CITATION LIST

### Patent Document

Patent Document 1: Japanese Patent No. 7064064
Patent Document 2: Japanese Unexamined Patent Application, Publication No. H5-19837

### DISCLOSURE OF THE INVENTION

### Problems to be Solved by the Invention

In the technique described in Patent Document 1, the overlap between tool paths of one tool edge can be checked, but it is difficult to grasp the overlap between the tool paths of a plurality of tool edges. In this regard, the technique described in Patent Document 2 is based on the premise that a plurality of tool edges are used. However, even when the positional relationship between a plurality of tool edges can be grasped, the overlap between tool paths of the plurality of tool edges cannot be grasped, because rendering is not performed in consideration of the relative rotation angle between a workpiece and the tool.

The present disclosure is provided in view of the problem noted above, and an object thereof is to provide a technique that pertains to a display device for a machine tool and makes it possible to easily grasp the overlap between tool paths of the machine tool, which uses a plurality of tool edges.

### Means for Solving the Problems

The present disclosure pertains to a display device for a machine tool that performs machining while moving a cutting tool and a workpiece relative to each other, the display device including: a first tool path acquisition unit that acquires first tool path information, which pertains to a relative path between the workpiece and the tool that is based on a relative rotation angle formed between the workpiece and the tool by a first tool edge; a second tool path acquisition unit that acquires second tool path information, which pertains to a relative path between the workpiece and the tool that is based on a relative rotation angle formed between the workpiece and the tool by a second tool edge; and a display control unit that displays, on the same display unit on the basis of the first tool path information and the second tool path information, a first tool path indicating a path for the first tool edge and a second tool path indicating a path for the second tool edge.

### BRIEF DESCRIPTION OF THE DRAWINGS

FIG. 1 is a functional block diagram of a display device for a machine tool according to a first embodiment;

FIG. 2 is a flowchart illustrating an example of the flow of display control performed by the display device according to the first embodiment;

FIG. 3 illustrates a display example for a first tool path and a second tool path;

FIG. 4 illustrates a display example in which a first tool path and a second tool path are displayed in different display modes;

FIG. 5 illustrates a display example in which a portion of overlap between a first tool path and a second tool path is displayed in a different display mode; and

FIG. 6 is a flowchart illustrating an example of the flow of display control performed by a display device according to a second embodiment.

### PREFERRED MODE FOR CARRYING OUT THE INVENTION

The following describes embodiments of the present disclosure in detail by referring to the drawings. In the descriptions of the second embodiment and thereafter, like components are given like reference marks to those in the first embodiment, and descriptions thereof are omitted as appropriate herein.

### First Embodiment

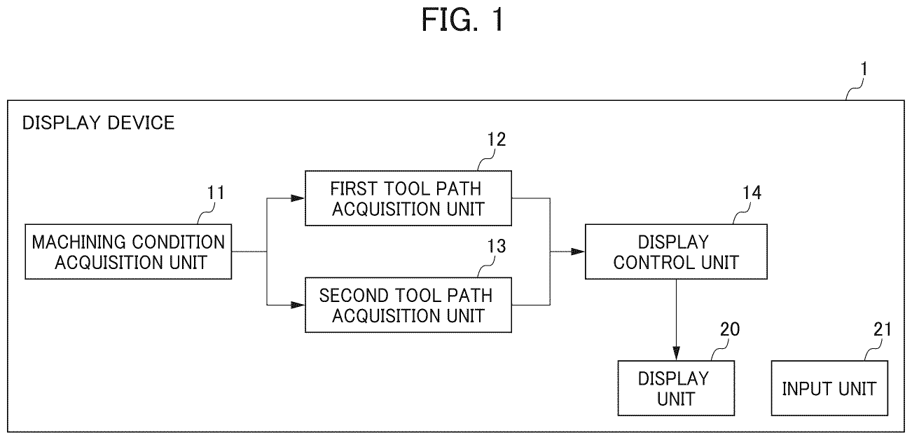

FIG. 1 is a functional block diagram of a display device 1 for a machine tool according to a first embodiment. The display device 1 according to the first embodiment is a computer that displays, on a display unit 20, various types of information on a machine tool for performing machining while moving a cutting tool and a workpiece relative to each other. For example, the display device 1 is used while connected to a control device (not shown) constituted by a computer for controlling the machine tool.

The machine tool subjects a workpiece to cutting machining by means of a tool by operating at least one spindle for rotating the tool and the workpiece relative to each other and at least one feed axis for moving the tool relative to the workpiece. The tool is a cutting tool that machines a workpiece by means of a plurality of tool edges including a first tool edge and a second tool edge. The first and second tool edges may indicate a plurality of edges of the same cutting tool, or may each be an independent cutting tool.

The machine tool performs various types of machining on the basis of a machining program. The machining program includes, for example, workpiece machining conditions. The workpiece machining conditions include the relative rotation speed between the workpiece and the cutting tool around the central axis of the workpiece or the tool, the relative feed speed between the cutting tool and the workpiece, and a position command for the feed axis.

The shape of a workpiece is not limited in the cutting machining performed by the machine tool according to the present embodiment. In particular, the present invention can be applied in both a case where a plurality of feed axes (Z-axis and X-axis) are necessary because of a workpiece having a tapered portion or an arc-shaped portion on a surface to be machined and a case where a feed axis for one specific axis (Z-axis) is sufficient because of a workpiece having a column shape or a cylindrical shape.

The following describes the hardware configuration of the display device 1 for the machine tool. For example, the display device 1 is formed using a computer provided with memories such as a read only memory (ROM) and a random access memory (RAM), a control processing unit (CPU), and a communication control unit, which are connected to each other via a bus. The display device 1 further includes the display unit 20 that displays various types of information as noted above, and an input unit 21 with which an operator inputs various types of information. For example, the display unit 20 is formed from a display that displays various types of information. The input unit 21 is an operation means, e.g., touch panel, keyboard, button.

The display device 1 for the machine tool may be formed as a computer numerical controller (CNC) or may be connected to a host computer (not shown) such as a CNC or a programmable logic controller (PLC). In addition to the machining program, machining conditions, etc. such as a rotation speed may be input from the host computer to the display device 1 for the machine tool via the input unit 21.

The following describes functional units implemented in the display device 1. The display device 1 includes a machining condition acquisition unit 11, a first tool path acquisition unit 12, a second tool path acquisition unit 13, and a display control unit 14 as functional units. The CPU, a memory, and a control program stored in the memory cooperate with each other, thereby implementing the functional units of the display device 1.

The machining condition acquisition unit 11 is a machining condition acquisition function for acquiring machining conditions under which cutting machining is to be performed. For example, the machining conditions may be input by an operator to the display device 1 via, for example, the input unit 21 or an external computer in accordance with a visual indication on the display unit 20 for the display device 1, or may be automatically acquired from, for example, the machining program or a setting parameter of the machine tool.

The machining conditions include information necessary for machining, such as a spindle rotation number, a feed speed, a workpiece diameter (mm), and a command position for the feed axis.

When oscillation machining is performed, the machining conditions include oscillation conditions. The oscillation conditions include, as information for uniquely identifying an oscillatory waveform, at least a frequency parameter, which is information pertaining to the oscillation count of the cutting tool or the workpiece, and an amplitude parameter, which is information pertaining to the oscillation amplitude of the cutting tool or the workpiece. The frequency parameter may be the number of relative vibrations between the cutting tool and the workpiece per rotation or per unit time. Alternatively, the frequency parameter may be one for a forward/rearward movement operation. The amplitude parameter may be information pertaining to an oscillation amplitude specific to the amount of relative feed between the cutting tool and the workpiece per rotation, or the distance parameter of the forward/rearward movement operation. The frequency parameter of the forward/rearward movement operation and the distance parameter of the forward/rearward movement operation may be decided on according to, for example, a forward movement speed, a rearward movement speed, a forward movement distance, a rearward movement distance, a spindle rotation number, and a control cycle. The frequency parameter and the amplitude parameter may be decided on according to, for example: the spindle rotation number; a per-rotation feed speed; a per-minute feed speed; a frequency multiplying factor, which is the number of relative vibrations between the cutting tool and the workpiece per rotation; and an amplitude multiplying factor, which is an oscillation amplitude specific to the amount of relative feed between the cutting tool and the workpiece per rotation.

In the present embodiment, an oscillation frequency multiplying factor (magnification) indicating an oscillation frequency per rotation of the spindle is used as the frequency parameter. The oscillation frequency multiplying factor (magnification) may be directly designed, or may be calculated from an oscillation frequency (Hz) and a spindle rotation number S (1/min) after the oscillation frequency (Hz) is designed.

Meanwhile, an oscillation amplitude multiplying factor (magnification) indicating the magnitude of an oscillation amplitude specific to the magnitude of the amount of feed per rotation of the spindle is used as the amplitude parameter. The oscillation amplitude multiplying factor (magnification) may also be directly designated.

The first tool path acquisition unit 12 is a first tool path acquisition function for acquiring first tool path information, which pertains to a relative path between the workpiece and the tool that is based on a relative rotation angle formed between the workpiece and the tool by a first tool edge. The first tool path information may be acquired from the machining conditions through calculation, or may be acquired on the basis of position feedback information.

The second tool path acquisition unit 13 is a second tool path acquisition function for acquiring second tool path information, which pertains to a relative path between the workpiece and the tool that is based on a relative rotation angle formed between the workpiece and the tool by a second tool edge. The second tool path information may also be acquired from the machining conditions through calculation, or may be acquired on the basis of position feedback information. Alternatively, when the machining conditions for the first tool edge and the machining conditions for the second tool edge are the same, the second tool path information may be acquired from the first tool path information and the relative positional relationship between the first and second tool edges.

The display control unit 14 is a display control function for displaying, on the display unit 20, various types of information on the display device 1 and information pertaining to the result of an operator input provided via the input unit 21. The display control unit 14 in the present embodiment can display a tool path based on the first tool path information and a tool path based on the second tool path information on the same screen of the display unit 20 in a superimposed manner.

Next, descriptions are given of display control performed by the display device 1 for a machine tool wherein a first tool edge and a second tool edge are disposed in the same drilling tool. In this example, the first tool edge of the machine tool that performs drilling indicates a first edge of the drilling tool, and the second tool edge thereof indicates a second edge of said drilling tool.

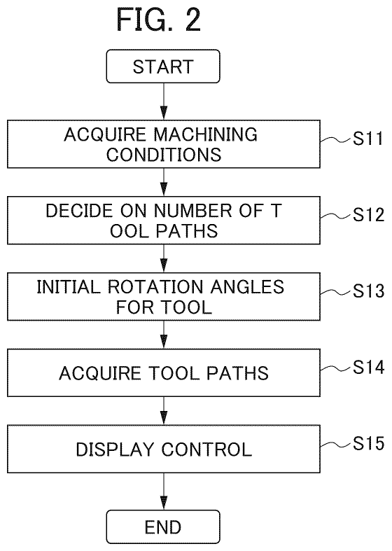

FIG. 2 is a flowchart illustrating an example of the flow of display control performed by the display device 1 according to the first embodiment. Note that the order indicated in the flowchart in which processing operations are performed and the details of the processing operations are nothing but examples, and can be changed as appropriate.

First, the machining condition acquisition unit 11 acquires machining conditions from an operator input or a machining program and/or from the parameters of the machine tool (Step S11). The machining conditions acquired by the machining condition acquisition unit 11 are, for example, a spindle rotation number S [rev/min], a feed speed F [mm/rev], a frequency parameter I [Hz/rev], an amplitude parameter K [mm/F], and the number of edges of the drilling tool.

Next, the machining condition acquisition unit 11 decides on the number of tool paths on the basis of the machining conditions (Step S12). In this example, the number of edges of the drilling tool is set to 2, and the machining condition acquisition unit 11 sets the number of tool paths to 2 in accordance with the number of edges of the drilling tool.

Subsequently, the first tool path acquisition unit 12 decides on an initial rotation angle for a first tool edge with respect to a workpiece, and the second tool path acquisition unit 13 decides on an initial rotation angle for a second tool edge with respect to the workpiece (Step S13). For example, the initial rotation angles of the first and second tool edges are acquired from an operator input or a machining program and/or from the parameters of the machine tool. In this example, the first tool path acquisition unit 12 and the second tool path acquisition unit 13 acquire information indicating that the first and second tool edges should be disposed so as to be point-symmetric with respect to the tool center, set a first tool initial rotation angle θ₀₁ to 0°, and set a second tool initial rotation angle θ₀₂ to 180°.

Then, the first tool path acquisition unit 12 acquires first tool path information indicating a path for the first tool edge, and the second tool path acquisition unit 13 acquires second tool path information indicating a path for the second tool edge (Step S14).

In this example, the first tool path acquisition unit 12 and the second tool path acquisition unit 13 calculate the first tool path information and the second tool path information on the basis of the numerical equations (1) to (3) presented below. In each of the numerical equations, F indicates the feed speed [mm/rev]; 0, the rotation angle of the tool with respect to the workpiece [°]; K, the amplitude parameter [mm/F]; I, the frequency parameter [Hz/rev]; and S, the spindle rotation number [rev/min]. The first tool path acquisition unit 12 calculates first tool path information z₁ in accordance with numerical equation (1). The second tool path acquisition unit 13 calculates second tool path information z₂ in accordance with numerical equation (2).

$$\begin{matrix}Formula 1 & \\ {z}_{1} = F \frac{θ}{2 π} + KF ( cos ( θ I + {θ}_{01} ) - 1 ) / 2 [ mm ] & Formula ( 1 )\end{matrix}$$

$$\begin{matrix}Formula 2 & \\ {z}_{1} = F \frac{θ}{2 π} + KF ( cos ( θ I + {θ}_{01} ) - 1 ) / 2 [ mm ] & Formula ( 2 )\end{matrix}$$

$$\begin{matrix}Formula 3 & \\ θ = 2 π \times St [ rad ] & Formula ( 3 )\end{matrix}$$

Next, the display control unit 14 performs display control for displaying, on the display unit 20, the first tool path information acquired by the first tool path acquisition unit 12 and the second tool path information acquired by the second tool path acquisition unit 13 (Step S15).

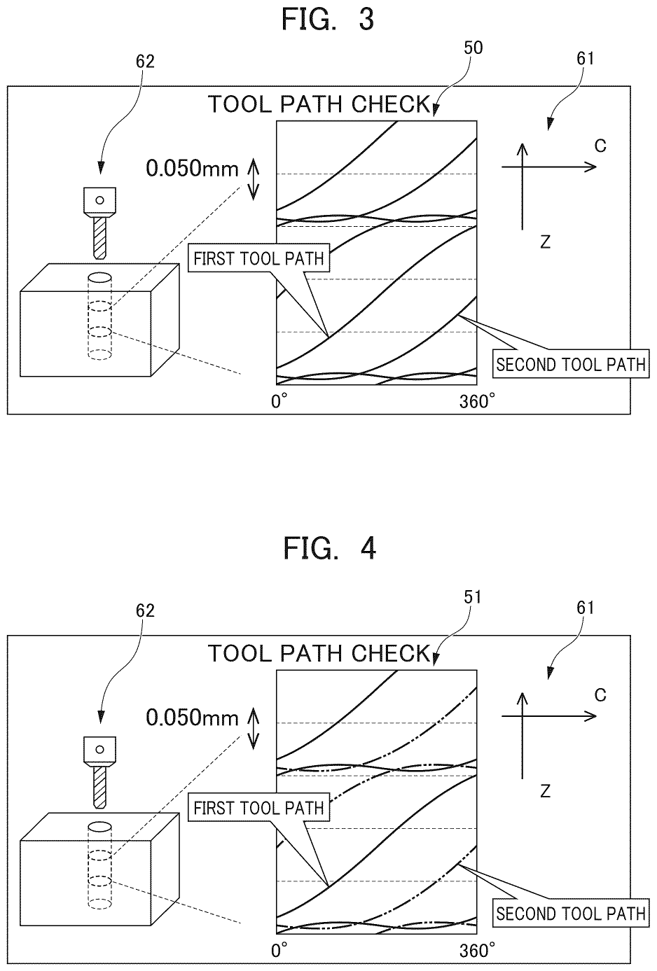

FIG. 3 illustrates a display example for a first tool path and a second tool path. In the example of FIG. 3, a graph 50 indicating the tool paths is presented in the middle, a schematic diagram 62 of drilling is presented on the left of the graph 50, and coordinate axes 61 are presented on the right of the graph 50. The graph indicating the tool paths has a horizontal axis indicating the rotation angle [°] and a vertical axis indicating the position in a Z-axis [mm], and the first and second tool paths are displayed in a superimposed manner. The schematic diagram 62 of drilling is information visually representing details of machining performed by the machine tool. The coordinate axes 61 indicate that the graph indicating the tool paths correspond to a rotation axis c and a z-axis orthogonal to the rotation axis.

In the processing in Step S15, meanwhile, the display control unit 14 may also display the first and second tool paths in display modes different from that in FIG. 3. FIG. 4 illustrates a display example in which the first tool path and the second tool path are displayed in different display modes.

FIG. 4 illustrates a graph 51 indicating the first and second tool paths in different display modes, together with the schematic diagram 62 of drilling and the coordinate axes 61. Although the graph 51 indicates different line types due to the figure restriction, display modes are not limited. The display control unit 14 can perform display control such that the first and second tool paths can be visually distinguished from each other by means of, for example, line colors or animation.

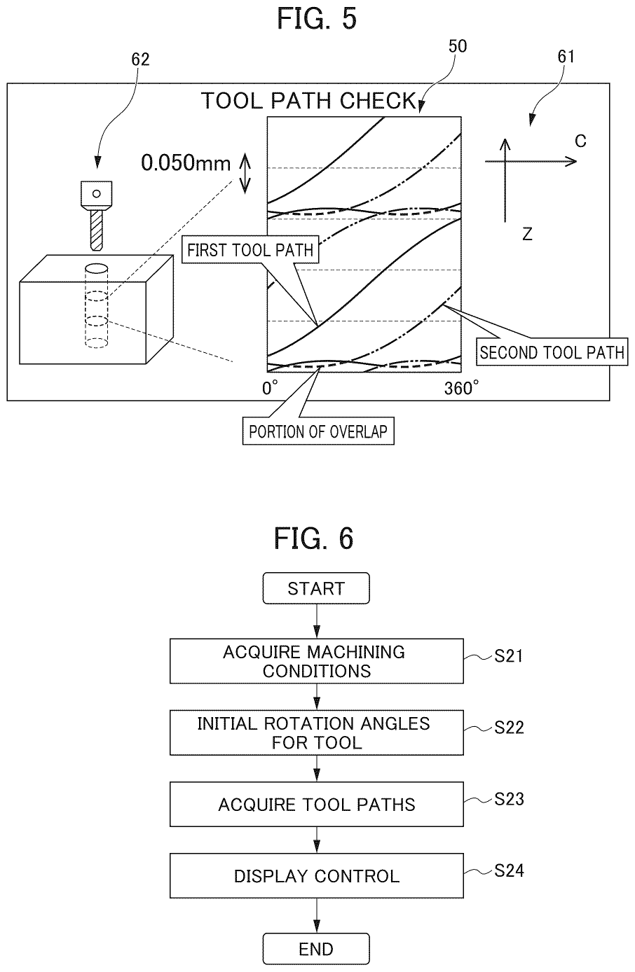

In the processing in Step S15, furthermore, the display control unit 14 may also display the first and second tool paths in display modes different from those in FIG. 4. FIG. 5 illustrates a display example in which a portion of overlap between the first tool path and the second tool path is displayed in a different display mode.

FIG. 5 illustrates a graph 52 indicating the first and second tool paths in different display modes, together with the schematic diagram 61 of drilling and the coordinate axes 62. In the graph 52, the first and second tool paths are displayed in different display modes, and a portion of overlap between the first and second tool paths is displayed in a different display mode so that the portion of overlap can be distinguished from the other portions. The portion of overlap is an air cut portion, and the other portions are to-be-actually-cut portions (constitute cutting-finished sites during machining). In the example of FIG. 5, the display control unit 14 can also perform display control such that the portion of overlap between the first and second tool paths can be visually distinguished from the other portions by means of, for example, line colors or animation. Alternatively, an area that belongs to the portion of overlap between the first and second tool paths and is surrounded by the first and second tool paths may be colored with a specific color or provided with a specific pattern, or a specific mark may be presented in the vicinity of the portion of overlap between the first and second tool paths.

In the example of FIG. 5, the portion of overlap between the first and second tool paths is displayed in the different display mode so that this portion can be distinguished from the other portions. However, display modes are not limited to this method. For example, different display modes may be used such that the portion of overlap between a current route and a previous route of a first tool path and the portion of overlap between a current route and a previous route of a second tool path can be distinguished from the other portions.

### Second Embodiment

The first embodiment has been described with respect to the display device 1 for a machine tool wherein the first and second tool edges are disposed in the same tool. Next, descriptions are given of a display device 1 for a machine tool in a second embodiment in which a first tool edge and a second tool edge are each a different tool and lathe turning is performed using a plurality of tools. Note that the configuration of the display device 1 in the second embodiment is the same as the configuration in the first embodiment depicted in FIG. 1.

FIG. 3 is a flowchart illustrating an example of the flow of display control performed by the display device 1 according to the second embodiment. The machining condition acquisition unit 11 acquires machining conditions from an operator input or a machining program and/or from the parameters of the machine tool (Step S21). The machining conditions acquired by the machining condition acquisition unit 11 are the number of tools and the spindle rotation number S [rev/min] as well as information set for each of the tools for the first and second tool edges.

The information set for the first tool edge is, for example, a feed speed F₁ [mm/rev], a frequency parameter I₁ [Hz/rev], and an amplitude parameter K₁ [mm/F]. The information set for the second tool edge is, for example, a feed speed F₂ [mm/rev], a frequency parameter I₂ [Hz/rev], and an amplitude parameter K₂ [mm/F]. The information set for the first tool edge and the information set for the second tool edge may each have a different numerical value set therefor or may have the same numerical value set therefor.

Subsequently, the first tool path acquisition unit 12 decides on an initial rotation angle for the first tool edge with respect to a workpiece, and the second tool path acquisition unit 13 decides on an initial rotation angle for the second tool edge with respect to the workpiece (Step S22). In this example, as in the first embodiment, the first tool path acquisition unit 12 sets a first tool initial rotation angle θ₀₁ to 0°, and the second tool path acquisition unit 13 sets a second tool initial rotation angle θ₀₂ to 180°.

Then, the first tool path acquisition unit 12 acquires first tool path information indicating a path for the first tool edge, and the second tool path acquisition unit 13 acquires second tool path information indicating a path for the second tool edge (Step S23).

In this example, the first tool path acquisition unit 12 and the second tool path acquisition unit 13 calculate the first tool path information and the second tool path information on the basis of the numerical equations (4) to (6) presented below. In each of the numerical equations, θ indicates the rotation angle of the workpiece with respect to the first tool [ °]; and S, the spindle rotation number [rev/min]. F₁ indicates the feed speed of the first tool edge [mm/rev]; K₁, the amplitude parameter of the first tool edge [mm/F]; and I₁, the frequency parameter of the first tool edge [Hz/rev]. F₂ indicates the feed speed of the second tool edge [mm/rev]; K₂, the amplitude parameter of the second tool edge [mm/F]; and I₂, the frequency parameter of the second tool edge [Hz/rev]. The first tool path acquisition unit 12 calculates first tool path information z₁ in accordance with numerical equation (4). The second tool path acquisition unit 13 calculates second tool path information z₂ in accordance with numerical equation (5).

$$\begin{matrix}Formula 4 & \\ {z}_{1} = {F}_{1} \frac{θ}{2 π} + {K}_{1} {F}_{1} ( cos ( θ {I}_{1} + {θ}_{01} ) - 1 ) / 2 [ mm ] & Formula ( 4 )\end{matrix}$$

$$\begin{matrix}Formula 5 & \\ {z}_{2} = {F}_{2} \frac{θ}{2 π} + {K}_{2} {F}_{2} ( cos ( θ {I}_{1} + {θ}_{02} ) - 1 ) / 2 [ mm ] & Formula ( 5 )\end{matrix}$$

$$\begin{matrix}Formula 6 & \\ θ = 2 π \times St [ rad ] & Formula ( 6 )\end{matrix}$$

Next, the display control unit 14 performs display control for displaying, on the display unit 20, the first tool path information acquired by the first tool path acquisition unit 12 and the second tool path information acquired by the second tool path acquisition unit 13 (Step S24).

In the embodiment noted above, the first tool path acquisition unit 12 and the second tool path acquisition unit 13 are both configured to acquire a tool path on the basis of machining conditions. However, the present invention is not limited to this configuration. For example, during machining or after machining, the first tool path acquisition unit 12 acquires feedback information indicating the actual rotation angle and position (z₁, θ) of the first tool edge relative to the workpiece, and generates first tool path information on the basis of the feedback information. Likewise, the second tool path acquisition unit 13 acquires feedback information indicating the actual rotation angle and position (z₂, θ) of the second tool edge relative to the workpiece, and generates second tool path information on the basis of the feedback information. In this way, tool path information may be generated during machining on the basis of information differing from machining conditions. In this case, the acquiring of the number of tools, the deciding on an initial rotation angle, and the like may be processed using a similar method to the second embodiment.

The following effects are exhibited by the display device 1 for the machine tool according to the embodiments noted above that performs machining while moving the cutting tool and a workpiece relative to each other.

The display device 1 for a machine tool according to present embodiments includes a first tool path acquisition unit 12 that acquires first tool path information, which pertains to a relative path between a workpiece and a tool that is based on a relative rotation angle formed between the workpiece and the tool by a first tool edge; a second tool path acquisition unit 13 that acquires second tool path information, which pertains to a relative path between the workpiece and the tool that is based on a relative rotation angle formed between the workpiece and the tool by a second tool edge; and a display control unit 14 that displays, on the same display unit 20 on the basis of the first tool path information and the second tool path information, a first tool path indicating a path for the first tool edge and a second tool path indicating a path for the second tool edge.

Accordingly, when machining the same workpiece by using a plurality of tool edges, a tool path for each of the tool edges is rendered in consideration of the relative rotation angle between the workpiece and the tool, thereby making it possible to easily identify a portion where chip shredding will occur because of the tool paths of the tool edges having an overlap therebetween.

The display device 1 according to present embodiments further includes a machining condition acquisition unit 11 that acquires machining conditions for at least one of the first or second tool edge, and at least one of a first tool path acquisition unit 12 or a second tool path acquisition unit 13 generates tool path information on the basis of the machining conditions. Thus, since the machining conditions necessary for the machining performed by the machine tool can be used, tool path information can be easily acquired without additionally setting a tool path.

In present embodiments, the machining conditions acquired by the machining condition acquisition unit 11 include at least a frequency parameter and an amplitude parameter. Thus, the oscillatory waveform during oscillation machining can be uniquely identified according to the frequency parameter and the amplitude parameter, and tool paths can be accurately displayed.

In present embodiments, the display control unit 14 displays the first and second tool paths in different display modes. In this way, as indicated in FIG. 4, the first and second tool paths can be distinguished from each other more easily on the display unit 20.

In present embodiments, the display control unit 14 determines a to-be-actually-cut portion and an air cut portion on the tool path on the basis of the first tool path information and the second tool path information, and displays the to-be-actually-cut portion and the air cut portion in different display modes. In this way, a portion where an air cut portion is to occur can be grasped more easily.

In present embodiments, the display control unit 14 displays, in a different display mode, an air cut portion that will occur due to the second tool edge passing along the second tool path through a site already cut along the first tool path, or an air cut portion that will occur due to the first tool edge passing along the first tool path through a site already cut by the second tool edge. Thus, as indicated in FIG. 5, it is possible to more easily grasp portions of the tool paths for the first and second tool edges where an air cut will occur.

In the embodiments noted above, two paths, namely, the first and second tool paths, are displayed. However, the present invention is not limited to this feature. The display control unit 14 may also display three or more tool paths. Meanwhile, although the first tool path acquisition unit 12 and the second tool path acquisition unit 13 both calculate tool paths from machining conditions, the present invention is not limited to this feature. For example, one of the first tool path acquisition unit 12 or the second tool path acquisition unit 13 may calculate a tool path on the basis of machining conditions, and the other may calculate a tool path on the basis of information acquired from, for example, an operator input or an external computer.

The present disclosure is not limited to the embodiments noted above, and encompasses variations and improvements with which objects of the present disclosure can be achieved.

The following additional remarks are further disclosed with respect to the above-described embodiments and variations.

### Additional Remark 1

A display device (1) for a machine tool that performs machining while moving a cutting tool and a workpiece relative to each other, the display device (1) including:
a first tool path acquisition unit (12) that acquires first tool path information, which pertains to a relative path between the workpiece and the tool that is based on a relative rotation angle formed between the workpiece and the tool by a first tool edge;
a second tool path acquisition unit (13) that acquires second tool path information, which pertains to a relative path between the workpiece and the tool that is based on a relative rotation angle formed between the workpiece and the tool by a second tool edge; and
a display control unit (14) that displays, on the same display unit (20) on the basis of the first tool path information and the second tool path information, a first tool path indicating a path for the first tool edge and a second tool path indicating a path for the second tool edge.

### Additional Remark 2

The display device (1) further including: a machining condition acquisition unit (11) that acquires machining conditions for at least one of the first tool edge or the second tool edge, wherein
at least one of the first tool path acquisition unit (12) or the second tool path acquisition unit (13) generates tool path information on the basis of the machining conditions.

### Additional Remark 3

The display device (1) wherein
the machining conditions acquired by the machining condition acquisition unit include at least a frequency parameter and an amplitude parameter.

### Additional Remark 4

The display device (1) wherein
the display control unit (14) displays the first tool path and the second tool path in different display modes.

### Additional Remark 5

The display device (1) wherein
the display control unit (14)
determines a to-be-actually-cut portion and an air cut portion on the tool paths on the basis of the first tool path information and the second tool path information, and displays the to-be-actually-cut portion and the air cut portion in different display modes.

### Additional Remark 6

The display device (1) wherein
the display control unit (14)
displays, in a different display mode, an air cut portion that will occur due to the second tool edge passing along the second tool path through a site already cut along the first tool path, or an air cut portion that will occur due to the first tool edge passing along the first tool path through a site already cut by the second tool edge.

### EXPLANATION OF REFERENCE NUMERALS

1: Display device for machine tool
11: Machining condition acquisition unit
12: First tool path acquisition unit
13: Second tool path acquisition unit
14: Display control unit
20: Display unit

1. A display device for a machine tool that performs machining while moving a cutting tool and a workpiece relative to each other, the display device comprising:
a first tool path acquisition unit that acquires first tool path information, which pertains to a relative path between the workpiece and the tool that is based on a relative rotation angle formed between the workpiece and the tool by a first tool edge;
a second tool path acquisition unit that acquires second tool path information, which pertains to a relative path between the workpiece and the tool that is based on a relative rotation angle formed between the workpiece and the tool by a second tool edge; and
a display control unit that displays, on a same display unit on a basis of the first tool path information and the second tool path information, a first tool path indicating a path for the first tool edge and a second tool path indicating a path for the second tool edge.

2. The display device for the machine tool according to claim 1, the display device further comprising:
a machining condition acquisition unit that acquires machining conditions for at least one of the first tool edge or the second tool edge, wherein
at least one of the first tool path acquisition unit or the second tool path acquisition unit generates tool path information on a basis of the machining conditions.

3. The display device for the machine tool according to claim 2, wherein the machining conditions acquired by the machining condition acquisition unit include at least a frequency parameter and an amplitude parameter.

4. The display device for the machine tool according to claim 1, wherein the display control unit displays the first tool path and the second tool path in different display modes.

5. The display device for the machine tool according to claim 1, wherein
the display control unit
determines a to-be-actually-cut portion and an air cut portion on the tool paths on a basis of the first tool path information and the second tool path information, and
displays the to-be-actually-cut portion and the air cut portion in different display modes.

6. The display device for the machine tool according to claim 5, wherein
the display control unit
displays, in a different display mode, an air cut portion that will occur due to the second tool edge passing along the second tool path through a site already cut along the first tool path, or an air cut portion that will occur due to the first tool edge passing along the first tool path through a site already cut by the second tool edge.
